(19) United States
(12) Patent Application Publication
(10) Pub. No.: US 2021/0368947 A1
(43) Pub. Date: Dec. 2, 2021

(54) METHOD OF MANUFACTURING SHOE UPPER, SHOE UPPER, AND SHOE

(71) Applicant: ASICS CORPORATION, Kobe-shi, Hyogo (JP)

(72) Inventor: Shinsaku WAKASUGI, Kobe-shi, Hyogo (JP)

(73) Assignee: ASICS CORPORATION, Kobe-shi, Hyogo (JP)

(21) Appl. No.: 15/734,204

(22) PCT Filed: Dec. 20, 2019
(86) PCT No.: PCT/JP2019/050030

§ 371 Date: Dec. 1, 2020

(51) Int. Cl. A43D 11/01; A43B 23/02

(52) U.S. Cl. CPC A43D 11/01; A43B 23/0245

(57) ABSTRACT

A method of manufacturing a shoe upper according to the present invention includes: three-dimensionally forming an upper member; pre-heating the upper member such that a portion-to-be-reinforced of the three-dimensionally formed upper member is heated to a temperature equal to or higher than a melting point of thermoplastic resin powder; adhering the thermoplastic resin powder to the upper member so as to at least cover the portion-to-be-reinforced of the pre-heated upper member; further heating the upper member to which the thermoplastic resin powder is adhered and melting the thermoplastic resin powder adhered to the upper member; and hardening the melted thermoplastic resin powder to firmly adhere the reinforcing portion to the upper member.

### TECHNICAL FIELD

The present invention relates to a method of manufacturing a shoe upper, and also relates to a shoe upper and a shoe including the shoe upper.

### BACKGROUND ART

Shoe uppers each have a toe portion, a heel portion, an eyelet portion, a side surface portion, and the like, each of which may be provided with a reinforcing portion. This reinforcing portion is formed in many cases by providing a reinforcing member on the outer surface of each of the above-mentioned portions in the upper member. Also, a thermoplastic resin may recently be used for this reinforcing portion.

For example, U.S. Patent Publication No. 2018/0235320 (PTL 1) discloses a specific manufacturing method for providing a reinforcing portion in a shoe upper using thermoplastic resin powder. According to the manufacturing method disclosed in this publication, thermoplastic resin powder is first sprinkled over an upper member placed flatly on a conveyor and transported thereon. Thus, the thermoplastic resin powder is adhered to the upper member, which is then heated to thereby melt the thermoplastic resin powder on the upper member, which is then cooled to thereby form a reinforcing portion adhered to the upper member. Then, the upper member is cut, sewn or the like to thereby three-dimensionally form a shoe upper.

### CITATION LIST

### Patent Literature

PTL 1: U.S. Patent Publication No. 2018/0235320

### SUMMARY OF INVENTION

### Technical Problem

The manufacturing method disclosed in the above publication is however to provide a reinforcing portion in an upper member, and thereafter, three-dimensionally form a shoe upper. Thus, after formation of the reinforcing portion, this reinforcing portion may require shape processing. In this case, shape processing of the reinforcing portion may cause unintentional tension in the shoe upper, specifically, in a portion where the reinforcing portion is provided and a portion therearound. This may deteriorate the function of the reinforcing portion or impair the fitting performance.

In this regard, the above-mentioned problems can be avoided by three-dimensionally forming an upper member before providing a reinforcing portion in the upper member, and then, adhering thermoplastic resin powder to the three-dimensionally formed upper member. However, it is not easy to adhere a necessary amount of thermoplastic resin powder to a prescribed position in the three-dimensionally formed upper member with excellent reproducibility, which requires some modifications for implementation.

In addition, in the case where a shoe upper is manufactured according to the manufacturing method disclosed in the above-mentioned publication, a reinforcing portion cannot be formed in a joint, which is formed in the upper member during three-dimensional formation, in such a manner that the reinforcing portion extends over this joint. This also causes a problem that a sufficient reinforcing effect cannot be achieved at this joint.

Thus, the present invention has been made in light of the above-described problems, and an object of the present invention is to provide a method of manufacturing a shoe upper achieving a sufficient reinforcing effect while improving the fitting performance. Another object of the present invention is to provide a shoe upper achieving a high reinforcing effect and a shoe including the shoe upper.

### Solution to Problem

A method of manufacturing a shoe upper according to the present invention is a method for manufacturing a shoe upper including: an upper member including a reinforced portion; and a reinforcing portion that covers the reinforced portion to reinforce the upper member. The method includes: preparing the upper member; preparing thermoplastic resin powder to be formed as the reinforcing portion; three-dimensionally forming the upper member; pre-heating the three-dimensionally formed upper member such that a portion-to-be-reinforced of the three-dimensionally formed upper member is heated to a temperature equal to or higher than a melting point of the thermoplastic resin powder; adhering the thermoplastic resin powder to the upper member so as to at least cover the portion-to-be-reinforced of the pre-heated upper member; further heating the upper member to which the thermoplastic resin powder is adhered, and melting the thermoplastic resin powder adhered to the upper member; and hardening the melted thermoplastic resin powder to firmly adhere the reinforcing portion to the upper member.

The shoe upper according to the first aspect of the present invention includes: an upper member including a reinforced portion; and a reinforcing portion that covers the reinforced portion to reinforce the upper member. The reinforcing portion is formed by melting thermoplastic resin powder adhered to the upper member, and hardening the melted thermoplastic resin powder to be firmly adhered to the upper member. The reinforcing portion is provided to extend over a joint of the upper member.

A shoe upper according to the second aspect of the present invention includes: an upper member including a reinforced portion; and a reinforcing portion that covers the reinforced portion to reinforce the upper member. The reinforcing portion is formed by melting thermoplastic resin powder adhered to the upper member, and hardening the melted thermoplastic resin powder to be firmly adhered to the upper member. The reinforced portion of the upper member that is reinforced by the reinforcing portion is smaller in thickness than a portion other than the reinforced portion in the upper member.

A shoe according to the present invention includes: the shoe upper according to the above-mentioned first or second aspect of the present invention; and a shoe sole provided below the shoe upper.

### Advantageous Effects of Invention

According to the present invention, a method of manufacturing a shoe upper achieving a sufficient reinforcing effect while improving the fitting performance can be provided. According to the present invention, a shoe upper achieving a high reinforcing effect and a shoe including the shoe upper can be provided.

### BRIEF DESCRIPTION OF DRAWINGS

FIG. 1 is a perspective view of a shoe according to an embodiment.

FIG. 2 is a rear view of the shoe shown in FIG. 1.

FIG. 3 is an exploded perspective view of the shoe shown in FIG. 1.

FIG. 4 is an enlarged view of an end portion of a reinforcing portion of a shoe upper shown in FIG. 1.

FIG. 5 is a schematic cross-sectional view of the shoe upper, which is taken along a line V-V shown in FIG. 4.

FIG. 6 is a schematic cross-sectional view of a joint in an upper member of the shoe upper shown in FIG. 1.

FIG. 7 is a flowchart showing a method of manufacturing a shoe upper according to an embodiment.

FIG. 8 is a conceptual diagram showing a manufacturing apparatus for a shoe upper according to an embodiment.

FIG. 9 is a schematic diagram of a powder adhering unit shown in FIG. 8.

FIG. 10 shows schematic cross-sectional views of shoe uppers for a shoe according to the first and second modifications.

FIG. 11 shows schematic cross-sectional views of shoe uppers for a shoe according to the third and fourth modifications.

### DESCRIPTION OF EMBODIMENTS

Hereinafter, embodiments of the present invention will be described in detail with reference to the accompanying drawings. In the embodiments described below, the same or common portions are denoted by the same reference characters, and the description thereof will not be repeated.

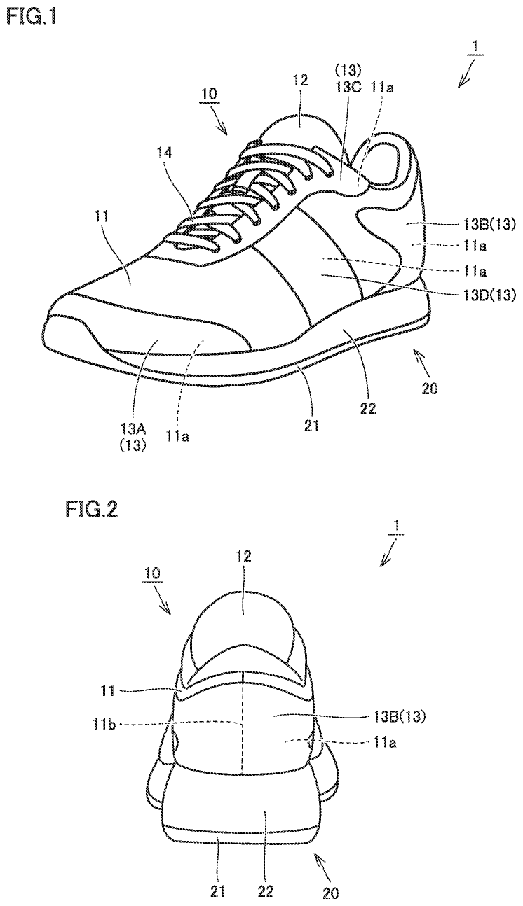

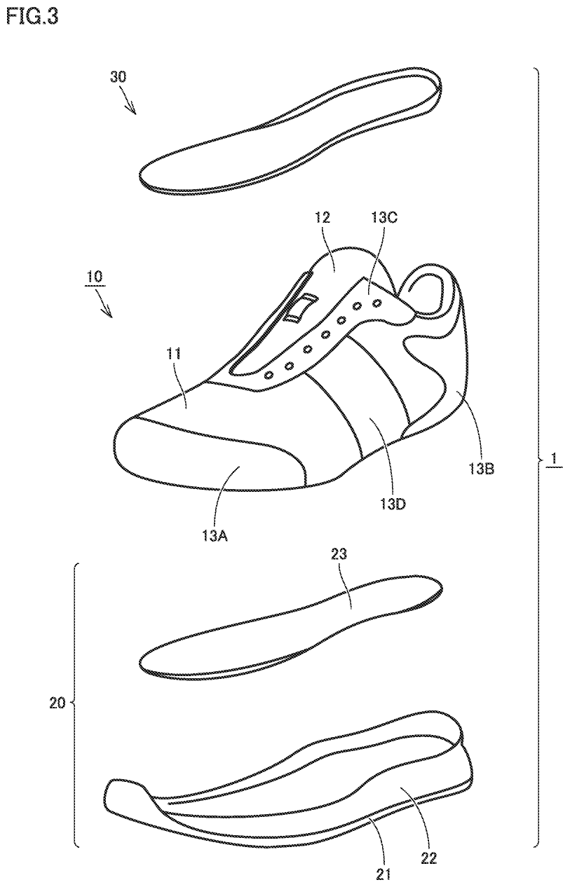

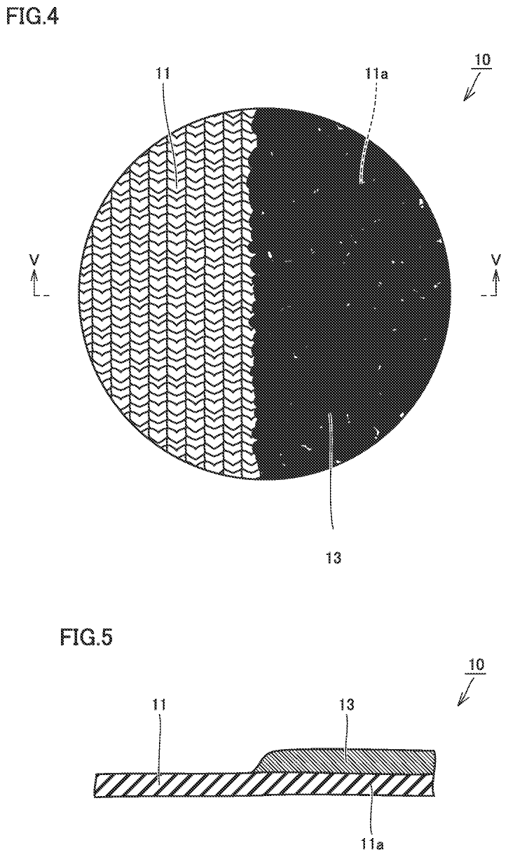

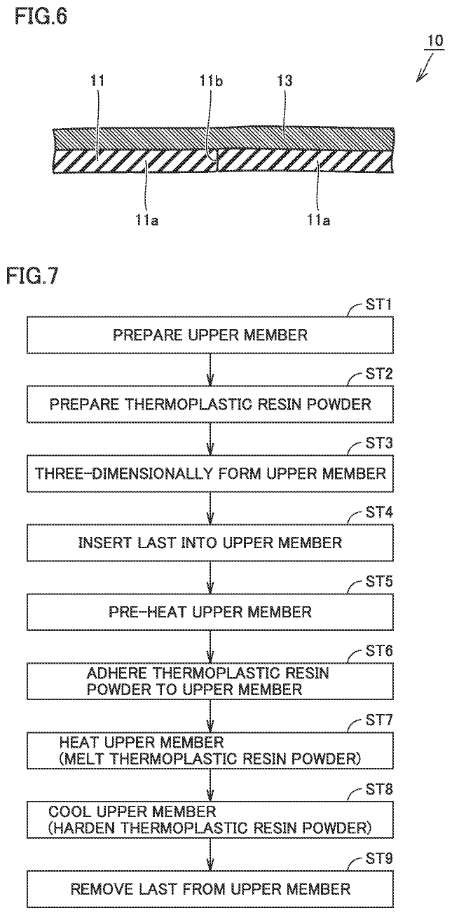

FIG. 1 is a perspective view of a shoe according to an embodiment. FIG. 2 is a rear view of the shoe shown in FIG. 1. FIG. 3 is an exploded perspective view of the shoe shown in FIG. 1. FIG. 4 is an enlarged view of an end portion of a reinforcing portion of a shoe upper shown in FIG. 1. FIG. 5 is a schematic cross-sectional view of the shoe upper, which is taken along a line V-V shown in FIG. 4. FIG. 6 is a schematic cross-sectional view of a joint in an upper member of the shoe upper shown in FIG. 1. Before describing a method of manufacturing a shoe upper according to the present embodiment, a shoe upper 10 according to the present embodiment manufactured by the manufacturing method and a shoe 1 including shoe upper 10 will be hereinafter first described with reference to FIGS. 1 to 6.

As shown in FIGS. 1 to 3, shoe 1 includes a shoe upper 10, a shoe sole 20, and a sockliner 30. Shoe upper 10 has a shape at least covering the entirety of a portion on the instep side of a foot inserted into the shoe. Shoe sole 20 is located below shoe upper 10 so as to cover the sole of a foot. Sockliner 30 is accommodated inside shoe upper 10 so as to cover the inner bottom surface of shoe upper 10.

Shoe upper 10 includes an upper member 11 as an upper body; a shoe tongue 12; a toe-side reinforcing portion 13A, a heel-side reinforcing portion 13B, an eyelet reinforcing portion 13C, and a side surface reinforcing portion 13D that serve as a reinforcing portion 13; and a shoelace 14. Among them, shoe tongue 12, toe-side reinforcing portion 13A, heel-side reinforcing portion 13B, eyelet reinforcing portion 13C, side surface reinforcing portion 13D, and shoelace 14 each are fixed or attached to upper member 11.

Upper member 11 has an upper portion provided with an upper opening through which an upper portion of an ankle and a portion of the instep of a foot are exposed. As one example, upper member 11 has a lower portion provided with a lower opening covered with shoe sole 20. As another example, upper member 11 has a lower portion having a lower end that is French-seamed to form a bottom portion. In this case, for providing a bottom portion in the lower portion of upper member 11, the bottom portion may be provided not only by the above-mentioned French-seaming, but also by forming upper member 11 entirely in a bag shape in advance by sock knitting, circular knitting, or the like.

Shoe tongue 12 is fixed to upper member 11, for example, by sewing, welding, bonding, or a combination thereof so as to cover a portion of the upper opening provided in upper member 11, through which a part of the instep of a foot is exposed. Upper member 11 and shoe tongue 12 are formed, for example, using woven fabric, knitted fabric, nonwoven fabric, synthetic leather, resin, or the like, and suitably using woven fabric, knitted fabric, or the like formed of a fiber material made of synthetic resin such as polyethylene terephthalate (PET) or nylon. The method of weaving woven fabric and the method of knitting knitted fabric are not particularly limited. For example, knitted fabric may be produced by various methods such as mesh knitting, flat knitting, circular knitting, and the like.

Toe-side reinforcing portion 13A and heel-side reinforcing portion 13B are provided for reinforcing a portion covering a toe of a foot and a portion covering a heel of a foot, respectively, in upper member 11 that are particularly required to have durability. Also, toe-side reinforcing portion 13A and heel-side reinforcing portion 13B are positioned so as to cover the outer surface of upper member 11 that corresponds to the portions as a reinforced portion 11a.

Eyelet reinforcing portion 13C is provided for reinforcing the peripheral edge of the upper opening, which is provided in upper member 11 and through which a part of the instep of a foot is exposed (the peripheral edge is specifically a portion to which shoelace 14 is attached). The peripheral edge is also a portion particularly required to have durability as in toe-side reinforcing portion 13A and heel-side reinforcing portion 13B. Eyelet reinforcing portion 13C is positioned so as to cover the outer surface of upper member 11 that corresponds to the above-mentioned portion as reinforced portion 11a.

Side surface reinforcing portion 13D is provided for reinforcing a portion that covers the side surface of a middle foot portion (described later) of upper member 11 and that is particularly required to have durability as in toe-side reinforcing portion 13A, heel-side reinforcing portion 13B, and eyelet reinforcing portion 13C. Side surface reinforcing portion 13D is positioned so as to cover the outer surface of upper member 11 that corresponds to the above-mentioned portion as reinforced portion 11a.

Toe-side reinforcing portion 13A, heel-side reinforcing portion 13B, eyelet reinforcing portion 13C, and side surface reinforcing portion 13D that serve as reinforcing portion 13 are formed of a resin-made member firmly adhered to the outer surface of upper member 11. More specifically, reinforcing portion 13 is formed by thermoplastic resin powder adhered to a portion-to-be-reinforced 11a of upper member 11 and firmly adhered to upper member 11, as will be described later in detail.

Shoelace 14 is formed of a string-shaped member for pulling, close in the foot width direction, the peripheral edge of the upper opening which is provided in upper member 11 and through which a part of the instep of a foot is exposed. Shoelace 14 is passed through a plurality of holes provided in the peripheral edge of the upper opening. When a foot is inserted into upper member 11 and shoelace 14 is tightened, upper member 11 can be brought into close contact with the foot.

Shoe sole 20 includes an outsole 21 and a midsole 22. Outsole 21 and midsole 22 are integrally formed to have a substantially flat shape as a whole. Outsole 21 has a lower surface including a tread. Midsole 22 is located above outsole 21.

Outsole 21 is preferably excellent in wear resistance and gripping performance. From this viewpoint, outsole 21 is formed using a member made of: a rubber material as a main component; and a material containing a plasticizer, a reinforcing agent, and a crosslinking agent as subcomponents.

Midsole 22 preferably excellently absorbs shock while having an appropriate strength. From this viewpoint, midsole 22 is preferably formed, for example, using: a resin material as a main component; and a resin-made foam material containing a foaming agent and a crosslinking agent as subcomponents. Alternatively, midsole 22 may be formed using a rubber-made foam material containing: a rubber material as a main component; and a plasticizer, a foaming agent, a reinforcing agent, and a crosslinking agent as subcomponents.

The above-mentioned resin material may be made using a thermoplastic resin and a thermosetting resin. A thermoplastic resin may be made suitably using ethylene-vinyl acetate copolymer (EVA), for example. A thermosetting resin may be made suitably using polyurethane (PU), for example. The above-mentioned rubber material may be made suitably using butadiene rubber, for example.

In addition to outsole 21 and midsole 22 as described above, shoe sole 20 may have an insole 23 as shown the figure. When shoe sole 20 has insole 23, insole 23 is attached to upper member 11 so as to cover the above-mentioned lower opening of upper member 11, or attached to upper member 11 so as to cover the bottom portion formed by French-seaming the above-mentioned lower end of upper member 11.

More specifically, insole 23 is fixed to upper member 11 by sewing or the like, and fixed to the upper surface of midsole 22 by bonding, welding or the like. Insole 23 is formed of: woven fabric, knitted fabric, or nonwoven fabric made of synthetic resin fibers such as polyester; or a resin-made foam material containing a resin material as a main component, and a foaming agent and a crosslinking agent as subcomponents.

Sockliner 30 is accommodated inside shoe upper 10 as described above, and is detachably attached onto the inner bottom surface of shoe upper 10 or fixed to the inner bottom surface of shoe upper 10 by welding, bonding, or the like. Sockliner 30 is formed of: woven fabric, knitted fabric, or nonwoven fabric made of synthetic resin fibers such as polyester; or formed of a resin-made foam material containing a resin material as a main component, and a foaming agent and a crosslinking agent as subcomponents. Sockliner 30 is provided for the purpose of allowing comfortable fittedness to a foot. Sockliner 30 is not indispensable and may not be provided.

As shown in FIGS. 4 to 6, in shoe 1 according to the present embodiment, reinforcing portion 13 is formed by thermoplastic resin powder adhered to portion-to-be-reinforced 11a of upper member 11 and firmly adhered to upper member 11, as described above. FIG. 4 relatively faithfully shows upper member 11 formed of knitted fabric. FIGS. 5 and 6 each show the shapes of upper member 11 and reinforcing portion 13 in a significantly simplified manner.

As shown in FIG. 4, reinforcing portion 13 does not necessarily completely cover portion-to-be-reinforced 11a of upper member 11, and the covering ratio of reinforcing portion 13 (that is, the ratio of the area of the portion actually covering portion-to-be-reinforced 11a to the total area of portion-to-be-reinforced 11a) is 50% or more and 100% or less, for example. In the case where the covering ratio is 100% or close to 100%, a high reinforcing effect is achieved. On the other hand, in the case where the covering ratio is reduced to some extent, the reinforcing effect can still be achieved while the portion provided with reinforcing portion 13 is kept, to some extent, readily elastically deformed.

Also, FIGS. 5 and 6 each show the case where reinforcing portion 13 is formed to have an approximately constant thickness, but reinforcing portion 13 does not necessarily have a constant thickness, and may have an uneven thickness. In this case, reinforcing portion 13 formed to have an approximately constant thickness allows a stable reinforcing effect to be achieved. On the other hand, reinforcing portion 13 formed to have a slightly uneven thickness allows a reinforcing effect to be still achieved while the portion provided with reinforcing portion 13 is kept, to some extent, readily elastically deformed.

Reinforcing portion 13 is made of a thermoplastic resin as described above. The thermoplastic resin suitably used herein may be ethylene-vinyl acetate copolymer (EVA), thermoplastic polyurethane (TPU), thermoplastic elastomer (TPE), and the like. The melting point of the thermoplastic resin is not particularly limited, but is preferably 80° C. or more and 120° C. or less.

The particle size of the thermoplastic resin powder as a raw material of reinforcing portion 13 is not particularly limited, but is preferably 0.1 mm or more and 5 mm or less, for example. When the thermoplastic resin powder having a particle size of 1 mm or more is used, reinforcing portion 13 and a portion of shoe upper 10 that includes reinforcing portion 13 can be maintained to have high elasticity while achieving a reinforcing effect. On the other hand, when thermoplastic resin powder having a particle size less than 1 mm is used, a high reinforcing effect can be achieved. Thus, such an effect is likely to differ between a low strain state and a high strain state in reinforcing portion 13 and a portion of shoe upper 10 that includes reinforcing portion 13.

Thermoplastic resin powder as a raw material of reinforcing portion 13 may be colored in a prescribed color. Thereby, the color of reinforcing portion 13 can be variously changed, thereby allowing an excellent design. This effect is particularly remarkable in side surface reinforcing portion 13D.

As shown in FIG. 5, at the end portion of reinforcing portion 13, upper member 11 is exposed due to discontinuation of covering by reinforcing portion 13 at a prescribed position of upper member 11. In other words, in the portion of upper member 11 that includes reinforcing portion 13, the outer surface of upper member 11 is covered by reinforcing portion 13. Accordingly, this portion of upper member 11 that includes reinforcing portion 13 is higher in strength than the portion of upper member 11 that is not covered by reinforcing portion 13.

On the other hand, as shown in FIG. 6, in shoe 1 according to the present embodiment, reinforcing portion 13 is provided also in a portion of upper member 11 where a joint 11b is located. As shown in FIG. 2, for example, joint 11b is provided in a portion of shoe upper 10 that covers a heel of a foot, and reinforcing portion 13 is provided to extend over joint 11b.

By the configuration as described above, reinforcing portion 13 is provided to extend over joint 11b at the portion of shoe upper 10 where joint 11b is provided, thereby allowing shoe upper 10 achieving a high reinforcing effect.

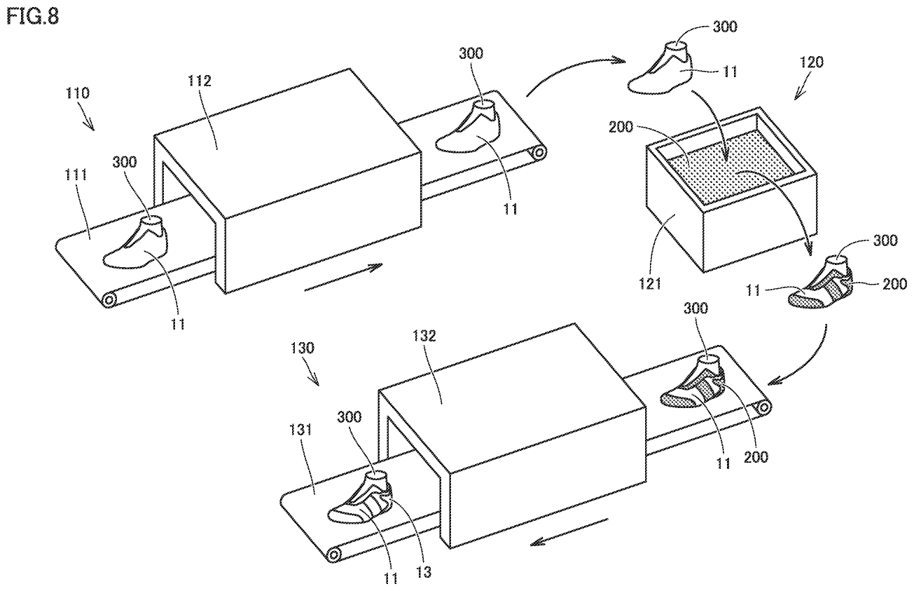

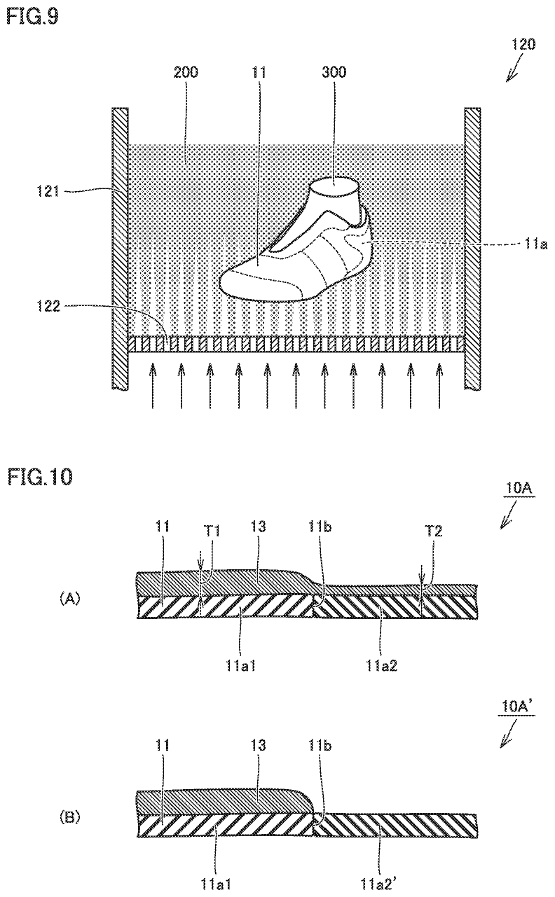

FIG. 7 is a flowchart showing a method of manufacturing the shoe upper according to the present embodiment. FIG. 8 is a conceptual diagram showing a manufacturing apparatus for a shoe upper according to the present embodiment. FIG. 9 is a schematic diagram of a powder adhering unit shown in FIG. 8. The following is an explanation about a method of manufacturing the shoe upper according to the present embodiment together with an explanation about one configuration example of a manufacturing apparatus for realizing the manufacturing method, with reference to FIGS. 7 to 9.

Shoe upper 10 according to the above-mentioned present embodiment can be manufactured according to a manufacturing flow shown in FIG. 7. The manufacturing flow will be hereinafter described in each step.

First, as shown in FIG. 7, upper member 11 is prepared in step ST1. Upper member 11 prepared in step ST1 is, for example, woven fabric, knitted fabric, nonwoven fabric, synthetic leather, resin, or the like, as described above.

Then, as shown in FIG. 7, thermoplastic resin powder to be formed as reinforcing portion 13 is prepared in step ST2. As described above, the thermoplastic resin powder prepared in step ST2 is, for example, EVA, TPU, TPE, or the like. The step of preparing thermoplastic resin powder may be performed at any timing before the step of pre-heating upper member 11, which will be described later.

Then, as shown in FIG. 7, upper member 11 is three-dimensionally formed in step ST3. Then, in step ST4, a last 300 (see FIG. 8 and the like) is inserted into the three-dimensionally formed upper member 11.

In this case, upper member 11 is three-dimensionally formed, for example, by cutting fabric or the like into a prescribed shape, removing upper member 11, three-dimensionally shaping the removed upper member 11, and joining required portions by stitching, welding, bonding, or a combination thereof. In the case where upper member 11 is entirely formed in a bag shape in advance by sock knitting, circular knitting, or the like, the above-mentioned stitching or the like is not required.

Last 300 is used to form and maintain the shape of the three-dimensionally formed upper member 11 in the shape of a final product. Last 300 is a mold imitating the shape of a foot. Last 300 may be inserted into the three-dimensionally formed upper member 11 as described above. Alternatively, during three-dimensional formation, upper member 11 may be wound around last 300 so as to be three-dimensionally shaped, which may result in the state where last 300 is inserted into the three-dimensionally formed upper member 11.

Then, as shown in FIG. 7, upper member 11 is pre-heated in step ST5; thermoplastic resin powder is adhered to upper member 11 in step ST6; upper member 11 is further heated in step ST7; and upper member 11 is cooled in step ST8. The series of steps is carried out, for example, in the manufacturing apparatus shown in FIG. 8.

As shown in FIG. 8, the manufacturing apparatus for a shoe upper according to the present embodiment includes a pre-heating device 110, a powder adhering unit 120, and a main heating device 130. The manufacturing apparatus applies a so-called line production system, and is configured such that upper member 11 as a workpiece can be automatically conveyed by using a transport device such as a conveyor or a picking arm.

Pre-heating device 110 serves to pre-heat upper member 11 in the above-mentioned step ST5, and mainly includes a conveyor 111 and a pre-heating furnace 112.

In pre-heating device 110, upper member 11 into which last 300 is inserted is delivered to a carry-in unit of conveyor 111, and transported by conveyor 111 and thereby introduced into pre-heating furnace 112. After passing through pre-heating furnace 112, the pre-heating of upper member 11 into which last 300 is inserted is completed. Then, the pre-heated upper member 11 is conveyed out from a carry-out unit of conveyor 111 by a picking arm (not shown).

In step ST5, upper member 11 is heated. Thereby, in particular, portion-to-be-reinforced 11a of upper member 11 is heated to a temperature equal to or higher than the melting point of thermoplastic resin powder 200. In this case, various methods are conceivable as a method of heating only portion-to-be-reinforced 11a of upper member 11 selectively to a temperature equal to or higher than the melting point of thermoplastic resin powder 200, which will be described later in detail.

Powder adhering unit 120 serves to adhere thermoplastic resin powder to upper member 11 in step ST6 described above, and mainly includes a fluid bath 121. In powder adhering unit 120, upper member 11 pre-heated by pre-heating device 110 is introduced into fluid bath 121 together with last 300 while being held by the above-mentioned picking arm (not shown), and thereafter, taken out from fluid bath 121.

More specifically, as shown in FIG. 9, powder adhering unit 120 includes a fluid bath 121 formed in a container shape and having an upper opening. Fluid bath 121 has a bottom portion provided with a plurality of holes 122. Fluid bath 121 is filled with a large quantity of thermoplastic resin powder 200. Also, a blower or the like blows air into fluid bath 121 through the plurality of holes 122.

Accordingly, in powder adhering unit 120, fluidic convection of thermoplastic resin powder 200 occurs inside fluid bath 121. Thus, the pre-heated upper member 11 is immersed in fluid bath 121, and thereby, thermoplastic resin powder 200 is adhered to upper member 11.

More specifically, in step ST6, thermoplastic resin powder 200 is selectively adhered so as to cover portion-to-be-reinforced 11a of upper member 11. This is because portion-to-be-reinforced 11a of upper member 11 is heated to a temperature equal to or higher than the melting point of thermoplastic resin powder 200 as described above, whereas a portion other than portion-to-be-reinforced 11a in upper member 11 is not heated to a temperature equal to or higher than the melting point of thermoplastic resin powder 200.

In other words, thermoplastic resin powder 200 coming into contact with portion-to-be-reinforced 11a receives heat of portion-to-be-reinforced 11a and thereby melts. Then, the viscosity of thermoplastic resin powder 200 lowers or, additionally, the temperature of thermoplastic resin powder 200 subsequently lowers, and thereby, thermoplastic resin powder 200 adheres to portion-to-be-reinforced 11a. Further, thermoplastic resin powder 200 that does not completely melt or does not melt at all may also adhere to portion-to-be-reinforced 11a by adhesiveness of thermoplastic resin powder 200 that has already melted. On the other hand, thermoplastic resin powder 200 coming into contact with a portion other than portion-to-be-reinforced 11a receives heat from this portion, but does not adhere to this portion since the received heat is not sufficient to melt thermoplastic resin powder 200.

Thus, thermoplastic resin powder 200 adheres only to portion-to-be-reinforced 11a of the three-dimensionally formed upper member 11, thereby allowing selective adhesion of thermoplastic resin powder 200 to the portion requiring reinforcement. In addition to the above-described methods, various methods may also be conceivable as a method of adhering thermoplastic resin powder 200 to portion-to-be-reinforced 11a of upper member 11, which will be described later in detail.

In the above-mentioned step S6, excessive thermoplastic resin powder 200 unintentionally accumulated in a portion other than portion-to-be-reinforced 11a (for example, thermoplastic resin powder 200 sandwiched between fibers of upper member 11, or the like) may be removed from upper member 11, for example, by air blowing or vibrations.

Main heating device 130 serves to further heat upper member 11 in the above-described step ST7, and mainly includes a conveyor 131 and a main heating furnace 132. In main heating device 130, upper member 11 to which thermoplastic resin powder 200 is adhered is delivered to a carry-in unit of conveyor 131 by the above-mentioned picking arm (not shown), and transported by conveyor 131 and thereby introduced into main heating furnace 132.

In step ST7, upper member 11 is further heated, and thereby, portion-to-be-reinforced 11a of upper member 11 is again heated to a temperature equal to or higher than the melting point of thermoplastic resin powder 200. Thereby, thermoplastic resin powder 200 adhered to portion-to-be-reinforced 11a melts, and thus, wets and spreads on portion-to-be-reinforced 11a in a layered manner, with the result that portion-to-be-reinforced 11a is covered with a layer of the thermoplastic resin.

Thermoplastic resin powder 200 melted by such main heating includes: thermoplastic resin powder 200 that is already melted in the above-mentioned pre-heating, and then, hardened and thereby adhered to portion-to-be-reinforced 11a; thermoplastic resin powder 200 that adheres to portion-to-be-reinforced 11a without completely melting or without melting at all as described above; and the like. In addition to the above-described heating method, various methods are also conceivable as a heating method employed at this time, which will be described later in detail.

After passing through main heating furnace 132, main heating of upper member 11 into which last 300 is inserted completes. After completion of main heating, upper member 11 is transported to the carry-out unit of conveyor 131. Thereby, upper member 11 is cooled in step ST8, and then, the layer of the thermoplastic resin that covers portion-to-be-reinforced 11a of upper member 11 is hardened, with the result that reinforcing portion 13 is firmly adhered to upper member 11.

Then, upper member 11 is conveyed out from the carry-out unit of conveyor 131, and also, last 300 is removed from upper member 11 in step ST9 as shown in FIG. 7. This completes production of upper member 11 having reinforced portion 11a covered by reinforcing portion 13.

In this case, in addition to the above-mentioned heating method using a heating furnace, the method of heating upper member 11 in step ST5 (that is, a pre-heating method) may include various heating methods such as oven heating, heater heating, heat gun heating, microwave heating, and laser heating.

When oven heating is employed, upper member 11 is entirely uniformly heated. Thus, materials different in property (that is, materials different in thermal conductivity) are used to form portion-to-be-reinforced 11a of upper member 11 and the portion other than portion-to-be-reinforced 11a, thereby allowing a difference in heating temperature. In addition, a thickness difference between portion-to-be-reinforced 11a of upper member 11 and the portion other than portion-to-be-reinforced 11a also allows a difference in heating temperature. The same applies not only in the case of oven heating but also in the case of the above-mentioned heating using a heating furnace, which will be described later in detail.

When heater heating or heat gun heating is used, upper member 11 can be partially heated, so that only portion-to-be-reinforced 11a can be selectively locally heated. This allows a difference in heating temperature between portion-to-be-reinforced 11a of upper member 11 and the portion other than portion-to-be-reinforced 11a.

When microwave heating is used, upper member 11 is entirely uniformly heated. Thus, materials different in property (that is, materials different in dielectric constant) are used to form portion-to-be-reinforced 11a of upper member 11 and the portion other than portion-to-be-reinforced 11a, thereby allowing a difference in heating temperature. Also when the material having the same property is used to form portion-to-be-reinforced 11a of upper member 11 and the portion other than portion-to-be-reinforced 11a, last 300 inserted into upper member 11 is formed using materials different in property (that is, materials different in dielectric constant) at a position corresponding to portion-to-be-reinforced 11a and a position corresponding to the portion other than portion-to-be-reinforced 11a, thereby allowing a difference in heating temperature.

When laser heating is used, upper member 11 can be partially heated, so that only portion-to-be-reinforced 11a can be selectively locally heated, thereby allowing a difference in heating temperature between portion-to-be-reinforced 11a of upper member 11 and the portion other than portion-to-be-reinforced 11a.

In addition to the above-mentioned heating method using a heating furnace, the method of heating upper member 11 in step ST7 (that is, a main heating method) may include various heating methods such as oven heating, heater heating, heat gun heating, microwave heating, and laser heating, similarly to the above-mentioned pre-heating method.

Also, in addition to the above-mentioned adhering method using a fluid bath, the method of adhering thermoplastic resin powder 200 to upper member 11 in step ST6 may include a method of spraying thermoplastic resin powder 200 to upper member 11 using a curtain-type or spray-type spraying device, and thereby, adhering thermoplastic resin powder 200 to upper member 11.

Also, in addition to the above-mentioned method using pre-heating, the method of adhering thermoplastic resin powder 200 selectively only to portion-to-be-reinforced 11a of the three-dimensionally formed upper member 11 may include various methods such as an adhering method using static electricity, an adhering method using a liquid, and an adhering method using surface processing, for example.

According to the adhering method using static electricity, at least one of portion-to-be-reinforced 11a of upper member 11 and thermoplastic resin powder 200 is electrostatically charged in advance, and thermoplastic resin powder 200 is supplied to portion-to-be-reinforced 11a of upper member 11 in this state, and thereby, thermoplastic resin powder 200 is adhered by means of electrostatic attraction selectively only to portion-to-be-reinforced 11a of the three-dimensionally formed upper member 11. When the adhering method utilizing static electricity is used, the thickness of reinforcing portion 13 can be readily controlled, so that a desired reinforcing effect can be reliably achieved.

Also, at least one of portion-to-be-reinforced 11a of upper member 11 and thermoplastic resin powder 200 can be electrostatically charged in advance by applying a voltage or friction and, as an example, by a technique similar to an electrostatic coating technique using an electrostatic spray gun.

According to the adhering method using a liquid, a liquid is applied in advance to portion-to-be-reinforced 11a of upper member 11, and thermoplastic resin powder 200 is supplied to portion-to-be-reinforced 11a of upper member 11 in this state, so that thermoplastic resin powder 200 is adhered selectively only to portion-to-be-reinforced 11a of the three-dimensionally formed upper member 11 by means of the surface tension of the liquid. In this case, liquid that can be effectively used may be water under an environment of a normal pressure of 100° C. or less, but may be various types of oils, adhesive agents, and the like other than water.

According to the adhering method using surface processing, thermoplastic resin powder 200 is subjected to surface processing in advance to increase the adhesiveness of thermoplastic resin powder 200 to upper member 11, and thereby, thermoplastic resin powder 200 is locally sprayed and adhered selectively only to portion-to-be-reinforced 11a of the three-dimensionally formed upper member 11. As surface processing, it is conceivable to apply a functional group, which is readily adhered to upper member 11, to the surface of thermoplastic resin powder 200.

Furthermore, the surface of portion-to-be-reinforced 11a of upper member 11 and the surface of thermoplastic resin powder 200 may be formed to have significantly small projections and recesses. This can increase the adhesiveness of thermoplastic resin powder 200 to portion-to-be-reinforced 11a of upper member 11. Thus, thermoplastic resin powder 200 can be adhered selectively only to portion-to-be-reinforced 11a of the three-dimensionally formed upper member 11.

Note that the method of adhering thermoplastic resin powder 200 selectively only to portion-to-be-reinforced 11a of the three-dimensionally formed upper member 11 as described above includes an adhering method using static electricity, an adhering method using a liquid, an adhering method using surface processing, and the like, which may be used alone or may be used in combination with one another. Furthermore, these adhering methods may be combined with the above-mentioned method using pre-heating.

In the above-described method of manufacturing a shoe upper according to the present embodiment, before providing reinforcing portion 13 in upper member 11, upper member 11 is three-dimensionally formed, and then, thermoplastic resin powder 200 is adhered to the three-dimensionally formed upper member 11. In this case, a required amount of thermoplastic resin powder 200 can be adhered to portion-to-be-reinforced 11a of the three-dimensionally formed upper member 11 with excellent reproducibility.

Accordingly, reinforcing portion 13 itself is formed to have a desired shape during its formation, so that unintentional tension can be prevented from occurring in shoe upper 10, specifically, in a portion provided with reinforcing portion 13 and a region therearound. Therefore, the method of manufacturing a shoe upper according to the present embodiment can implement a method of manufacturing a shoe upper achieving a sufficient reinforcing effect while improving the fitting performance.

Furthermore, shoe upper 10 according to the above-mentioned present embodiment and shoe 1 including shoe upper 10 can implement a shoe upper achieving a high reinforcing effect and a shoe including the shoe upper.

In the above-described present embodiment, the step of pre-heating upper member 11 (step ST5), the step of adhering thermoplastic resin powder 200 to upper member 11 (step ST6), and the step of melting thermoplastic resin powder 200 adhered to upper member 11 (step ST7) each are performed in the state where last 300 is inserted into upper member 11. In this way, changes in shape and temperature of upper member 11 can be suppressed, and thus, the operation in each step can be more readily performed. Furthermore, when last 300 is formed of a metal member, the heating efficiency of upper member 11 can also be increased, with the result that thermoplastic resin powder 200 is more smoothly melted.

Also, the above present embodiment has been described by way of example with reference to the case where one type of thermoplastic resin powder 200 is used, but a plurality of types of thermoplastic resin powder 200 may be used instead. Specifically, when one type of thermoplastic resin powder 200 is used, a plurality of reinforcing portions 13 basically have the same performance. However, when a plurality of types of thermoplastic resin powder 200 are used, the plurality of reinforcing portions 13 can be varied in performance.

For example, thermoplastic resin powder 200 used herein may include: first resin powder having a relatively large particle size (for example, a particle size of 1 mm or more); and second resin powder having a relatively small particle size (for example, a particle size less than 1 mm). Then, heel-side reinforcing portion 13B may be formed of the first resin powder while toe-side reinforcing portion 13A and side surface reinforcing portion 13D may be formed of the second resin powder.

In such a configuration, the above-mentioned performance can be achieved in heel-side reinforcing portion 13B that requires highly strong reinforcement, and also, the above-mentioned performance can be achieved in toe-side reinforcing portion 13A and side surface reinforcing portion 13D that require the durability to be enhanced by preventing peeling or the like between upper member 11 and reinforcing portion 13.

Heel-side reinforcing portion 13B can be formed as a heel counter in various shapes, thicknesses, positions, and the like in accordance with the use of shoes (i.e., sports or the like for which the shoes are used).

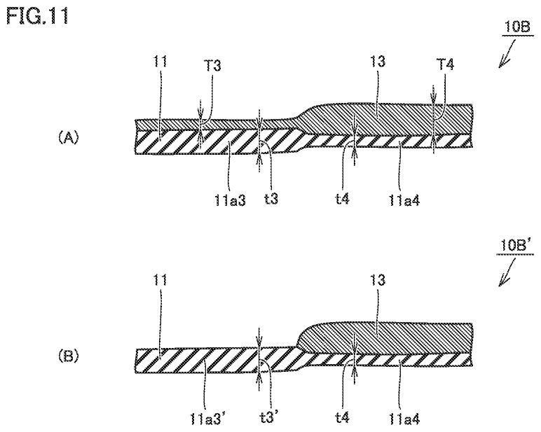

FIGS. 10(A) and 10(B) show schematic cross-sectional views of shoe uppers for a shoe according to the first modification and the second modification, respectively. Also, FIGS. 11(A) and 11(B) show schematic cross-sectional views of shoe uppers for a shoe according to the third modification and the fourth modification, respectively. The following is an explanation about shoe uppers 10A, 10N, 10B, and 10B′ for shoes according to the first to fourth modifications based on the above-described embodiments with reference to FIGS. 10(A), 10(B), 11(A), and 11(B).

As described above, in the case of heating using a heating furnace or pre-heating using oven heating, portion-to-be-reinforced 11a of upper member 11 and the portion other than portion-to-be-reinforced 11a are formed using materials different in property or formed to have different thicknesses, thereby allowing a difference in heating temperature.

In shoe upper 10A according to the first modification shown in FIG. 10(A), upper member 11 includes reinforced portions 11a1 and 11a2 made of materials different in property. These reinforced portions 11a1 and 11a2 are joined through a joint 11b. In this case, reinforced portion 11a1 is higher in thermal conductivity than reinforced portion 11a2.

In such a configuration, also when upper member 11 is entirely uniformly heated, a portion-to-be-reinforced 11a1 becomes higher in temperature than a portion-to-be-reinforced 11a2. Thereby, the amount of resin adhered onto portion-to-be-reinforced 11a1 becomes different from the amount of resin adhered onto portion-to-be-reinforced 11a2, with the result that reinforcing portion 13 can be varied in thickness between reinforced portion 11a1 and reinforced portion 11a2. Thus, a thickness T1 of reinforcing portion 13 on portion-to-be-reinforced 11a1 that is heated to a higher temperature can be larger than a thickness T2 of reinforcing portion 13 on portion-to-be-reinforced 11a2 that is heated to a lower temperature.

In shoe upper 10A′ according to the second modification shown in FIG. 10(B), upper member 11 includes a reinforced portion 11a1 and an unreinforced portion 11a2′ that are made of materials different in property. Also, these reinforced portion 11a1 and unreinforced portion 11a2′ are joined through a joint 11b. In this case, reinforced portion 11a1 is higher in thermal conductivity than unreinforced portion 11a2′.

In such a configuration, the heating condition is adjusted during pre-heating such that portion-to-be-reinforced 11a1 having a higher thermal conductivity is heated to a temperature higher than the melting point of the thermoplastic resin powder and such that a portion-to-be-unreinforced 11a2′ having a lower thermal conductivity is heated to a temperature lower than the melting point of the thermoplastic resin powder, and thereby, reinforcing portion 13 can be formed selectively only on portion-to-be-reinforced 11a1 without forming reinforcing portion 13 on portion-to-be-unreinforced 11a2′.

In shoe upper 10B according to the third modification shown in FIG. 11(A), upper member 11 includes reinforced portions 11a3 and 11a4 having different thicknesses. In this case, a thickness t3 of reinforced portion 11a3 is larger than a thickness t4 of reinforced portion 11a4.

In such a configuration, even when upper member 11 is entirely uniformly heated, a portion-to-be-reinforced 11a4 becomes higher in temperature than a portion-to-be-reinforced 11a3. This is because the surface temperature of portion-to-be-reinforced 11a4 having a smaller thickness is increased based on the difference in heat capacity resulting from the difference in thickness of upper member 11 itself, and based on the difference in heat conduction from last 300 to upper member 11. Thereby, reinforcing portion 13 formed on portion-to-be-reinforced 11a3 and portion-to-be-reinforced 11a4 can be varied in thickness between reinforced portion 11a3 and reinforced portion 11a4. Thus, a thickness T4 of reinforcing portion 13 on portion-to-be-reinforced 11a4 that is heated to a higher temperature can be larger than a thickness T3 of reinforcing portion 13 on portion-to-be-reinforced 11a3 that is heated to a lower temperature.

In shoe upper 10B′ according to the fourth modification shown in FIG. 11(B), upper member 11 includes an unreinforced portion 11a3′ and a reinforced portion 11a4 that are different in thickness. In this case, a thickness t3′ of unreinforced portion 11a3′ is larger than a thickness t4 of reinforced portion 11a4.

In such a configuration, the heating condition is adjusted during pre-heating such that portion-to-be-reinforced 11a4 having a smaller thickness is heated to a temperature higher than the melting point of the thermoplastic resin powder and such that a portion-to-be-unreinforced 11a3′ having a larger thickness is heated to a temperature lower than the melting point of the thermoplastic resin powder, and thereby, reinforcing portion 13 can be formed selectively only on portion-to-be-reinforced 11a4 without forming reinforcing portion 13 on portion-to-be-unreinforced 11a3′.

### Summary of Disclosure in Embodiments and the Like

The characteristic configurations disclosed in the above-described embodiments and modifications thereof will be summarized as follows.

A method of manufacturing a shoe upper according to an aspect of the present disclosure is a method for manufacturing a shoe upper including: an upper member including a reinforced portion; and a reinforcing portion that covers the reinforced portion to reinforce the upper member. The method includes: preparing the upper member; preparing thermoplastic resin powder to be formed as the reinforcing portion; three-dimensionally forming the upper member; pre-heating the three-dimensionally formed upper member such that a portion-to-be-reinforced of the three-dimensionally formed upper member is heated to a temperature equal to or higher than a melting point of the thermoplastic resin powder; adhering the thermoplastic resin powder to the upper member so as to at least cover the portion-to-be-reinforced of the pre-heated upper member; further heating the upper member to which the thermoplastic resin powder is adhered, and melting the thermoplastic resin powder adhered to the upper member; and hardening the melted thermoplastic resin powder to firmly adhere the reinforcing portion to the upper member.

In the method of manufacturing a shoe upper according to an aspect of the above-described present disclosure, the adhering the thermoplastic resin powder to the upper member may be performed in a state where at least one of the upper member and the thermoplastic resin powder is electrostatically charged.

In the method of manufacturing a shoe upper according to an aspect of the above-described present disclosure, the adhering the thermoplastic resin powder to the upper member may be performed in a state where a liquid is applied in advance to the portion-to-be-reinforced of the upper member.

In the method of manufacturing a shoe upper according to an aspect of the above-described present disclosure, at least one of a surface of the portion-to-be-reinforced of the upper member and a surface of the thermoplastic resin powder may be formed to have projections and recesses.

In the method of manufacturing a shoe upper according to an aspect of the above-described present disclosure, the adhering the thermoplastic resin powder to the upper member may be performed by spraying the thermoplastic resin powder onto the upper member.

In the method of manufacturing a shoe upper according to an aspect of the above-described present disclosure, the adhering the thermoplastic resin powder to the upper member may be performed by immersing the upper member in the thermoplastic resin powder in a convective state.

In the method of manufacturing a shoe upper according to an aspect of the above-described present disclosure, the pre-heating the upper member and the melting the thermoplastic resin powder adhered to the upper member may be performed by one of oven heating, heater heating, heat gun heating, microwave heating, and laser heating.

In the method of manufacturing a shoe upper according to an aspect of the above-described present disclosure, the pre-heating the upper member, the adhering the thermoplastic resin powder to the upper member, and the melting the thermoplastic resin powder adhered to the upper member may be performed in a state where a last is inserted into the upper member.

In the method of manufacturing a shoe upper according to an aspect of the above-described present disclosure, the reinforcing portion may be provided in a portion of the upper member that covers a toe of a foot and a portion of the upper member that covers a heel of the foot.

In the method of manufacturing a shoe upper according to an aspect of the above-described present disclosure, the reinforcing portion may be provided in a portion of the upper member that covers a toe of a foot, a portion of the upper member that covers a side surface of a middle foot portion of the foot, and a portion of the upper member that covers a heel of the foot.

In the method of manufacturing a shoe upper according to an aspect of the above-described present disclosure, in the preparing the thermoplastic resin powder, first resin powder having a relatively large particle size and second resin powder having a relatively small particle size may be prepared as the thermoplastic resin powder. In this case, in the adhering the thermoplastic resin powder to the upper member, the first resin powder may be adhered to the portion of the upper member that covers the heel of the foot, and in the adhering the thermoplastic resin powder to the upper member, the second resin powder may be adhered to the portion of the upper member that covers the toe of the foot and the portion of the upper member that covers the side surface of the middle foot portion of the foot.

In the method of manufacturing a shoe upper according to an aspect of the above-described present disclosure, the reinforcing portion may be provided to extend over a joint of the upper member.

In the method of manufacturing a shoe upper according to an aspect of the above-described present disclosure, the portion-to-be-reinforced of the upper member that is reinforced by the reinforcing portion may be smaller in thickness than a portion other than the portion-to-be-reinforced in the upper member.

A shoe upper according to an aspect of the present disclosure includes an upper member including a reinforced portion, and a reinforcing portion that covers the reinforced portion to reinforce the upper member. The reinforcing portion is formed by melting thermoplastic resin powder adhered to the upper member, and hardening the melted thermoplastic resin powder to be firmly adhered to the upper member. The reinforcing portion is provided to extend over a joint of the upper member.

A shoe upper according to another aspect of the present disclosure includes: an upper member including a reinforced portion; and a reinforcing portion that covers the reinforced portion to reinforce the upper member. The reinforcing portion is formed by melting thermoplastic resin powder adhered to the upper member, and hardening the melted thermoplastic resin powder to be firmly adhered to the upper member. The reinforced portion of the upper member that is reinforced by the reinforcing portion is smaller in thickness than a portion other than the reinforced portion in the upper member.

In the shoe upper according to each of one aspect and another aspect of the above-described present disclosure, the reinforcing portion may be located in one of a portion of the upper member that covers a toe of a foot, a portion of the upper member that covers a side surface of a middle foot portion of the foot, and a portion of the upper member that covers a heel of the foot.

A shoe according to an aspect of the present disclosure includes: the shoe upper according to one aspect or another aspect of the above-described present disclosure; and a shoe sole provided below the shoe upper.

### Other Embodiments and the Like

The above embodiments and modifications thereof have been described by way of example with reference to the case where the a toe-side reinforcing portion, a heel-side reinforcing portion, an eyelet reinforcing portion, and a side surface reinforcing portion are provided as a reinforcing portion, but only one or only two or three of these reinforcing portions may be provided, or a reinforcing portion may be provided in a portion other than these portions. In the case where a reinforcing portion is provided in a portion other than these portions, for example, a shoe upper of a shoe for sports such as tennis may be provided with a reinforcing portion in a portion of the upper member that covers the upper surface or the like of toes of a foot.

Furthermore, the above embodiments and modifications thereof have been described by way of example with reference to the case where the side surface reinforcing portion is provided only in a portion on the lateral foot side of the middle foot portion in the upper member, but additionally or alternatively, the side surface reinforcing portion may be provided in a portion on the medial foot side of the middle foot portion in the upper member.

In this case, the reinforced portion of the upper member means not only a portion intended to be reinforced by providing a reinforcing portion, but also a portion to be reinforced consequently by the thermoplastic resin powder unintentionally adhered thereto during manufacturing. Further, the reinforced portion does not have to be a part of the upper member, but the entire upper member may be a reinforced portion.

Furthermore, the above embodiments and modifications thereof have been described by way of example with reference to a shoe configured such that an upper body is brought into close contact with a foot by a shoelace, but the shoe may be configured such that the upper body is brought into close contact with a foot by a hook-and-loop fastener, or the shoe may be configured to include a sock-shaped upper body not having a shoe tongue so as to allow the upper body to be brought into close contact with a foot only by inserting the foot into the upper body.

In addition, the present invention is suitably applicable when shoes are produced to order as a customized product in response to a request from a customer. Specifically, a shoe upper (or a shoe) already provided with a prescribed reinforcing portion or a shoe upper (or a shoe) not yet provided with a reinforcing portion is prepared in advance or after order reception. Then, the present invention is applied to each prepared shoe upper (or shoe) in response to a request from a customer, to thereby additionally form a reinforcing portion thereon, which can be produced and shipped as a customized product. In this case, for specifying the position where the reinforcing portion is formed, the color of the reinforcing portion, and the like, it is conceivable to employ a method for a store clerk or a customer to select a desired position and color from the options of positions and colors about the reinforcing portion that are displayed on a screen at a store or on the Internet.

Thus, the embodiments and modifications disclosed herein are illustrative and non-restrictive in every respect. The technical scope of the present invention is defined by the terms of the claims, and is intended to include any modifications within the meaning and scope equivalent to the terms of the claims.

### REFERENCE SIGNS LIST

1 shoe, 10, 10A, 10A′, 10B, 10B′ shoe upper, 11 upper member, 11a, 11a1 to 11a4 reinforced portion (portion-to-be-reinforced), 11a2′, 11a3′ unreinforced portion (portion-to-be-unreinforced), 11b joint, 12 shoe tongue, 13 reinforcing portion, 13A toe-side reinforcing portion, 13B heel-side reinforcing portion, 13C eyelet reinforcing portion, 13D side surface reinforcing portion, 14 shoelace, 20 shoe sole, 21 outsole, 22 midsole, 23 insole, 110 pre-heating device, 111 conveyor, 112 pre-heating furnace, 120 powder adhering unit, 121 fluid bath, 122 hole, 130 main heating device, 131 conveyor, 132 main heating furnace, 200 thermoplastic resin powder, 300 last.

1. A method of manufacturing a shoe upper including
an upper member including a reinforced portion, and
a reinforcing portion that covers the reinforced portion to reinforce the upper member, the method comprising:
preparing the upper member;
preparing thermoplastic resin powder to be formed as the reinforcing portion;
three-dimensionally forming the upper member; and
pre-heating the three-dimensionally formed upper member such that a portion-to-be-reinforced of the three-dimensionally formed upper member is heated to a temperature equal to or higher than a melting point of the thermoplastic resin powder;
adhering the thermoplastic resin powder to the upper member so as to at least cover the portion-to-be-reinforced of the pre-heated upper member;
further heating the upper member to which the thermoplastic resin powder is adhered, and melting the thermoplastic resin powder adhered to the upper member; and
hardening the melted thermoplastic resin powder to firmly adhere the reinforcing portion to the upper member.

2. The method of manufacturing a shoe upper according to claim 1, wherein the adhering the thermoplastic resin powder to the upper member is performed in a state where at least one of the upper member and the thermoplastic resin powder is electrostatically charged.

3. The method of manufacturing a shoe upper according to claim 1, wherein the adhering the thermoplastic resin powder to the upper member is performed in a state where a liquid is applied in advance to the portion-to-be-reinforced of the upper member.

4. The method of manufacturing a shoe upper according to claim 1, wherein the adhering the thermoplastic resin powder to the upper member is performed by immersing the upper member in the thermoplastic resin powder in a convective state.

5. The method of manufacturing a shoe upper according to claim 1, wherein the pre-heating the upper member, the adhering the thermoplastic resin powder to the upper member, and the melting the thermoplastic resin powder adhered to the upper member are performed in a state where a last is inserted into the upper member.

6. The method of manufacturing a shoe upper according to claim 1, wherein
the reinforcing portion is provided in
a portion of the upper member that covers a toe of a foot,
a portion of the upper member that covers a side surface of a middle foot portion of the foot, and
a portion of the upper member that covers a heel of the foot.

7. The method of manufacturing a shoe upper according to claim 6, wherein
in the preparing the thermoplastic resin powder, first resin powder having a relatively large particle size and second resin powder having a relatively small particle size are prepared as the thermoplastic resin powder,
in the adhering the thermoplastic resin powder to the upper member, the first resin powder is adhered to the portion of the upper member that covers the heel of the foot, and
in the adhering the thermoplastic resin powder to the upper member, the second resin powder is adhered to the portion of the upper member that covers the toe of the foot and the portion of the upper member that covers the side surface of the middle foot portion of the foot.

8. The method of manufacturing a shoe upper according to claim 1, wherein the reinforcing portion is provided to extend over a joint of the upper member.

9. The method of manufacturing a shoe upper according to claim 1, wherein the portion-to-be-reinforced of the upper member that is reinforced by the reinforcing portion is smaller in thickness than a portion other than the portion-to-be-reinforced in the upper member.

10. A shoe upper comprising:
an upper member including a reinforced portion; and
a reinforcing portion that covers the reinforced portion to reinforce the upper member, wherein
the reinforcing portion is formed by melting thermoplastic resin powder adhered to the upper member, and hardening the melted thermoplastic resin powder to be firmly adhered to the upper member, and
the reinforcing portion is provided to extend over a joint of the upper member.

11. A shoe upper comprising:
an upper member including a reinforced portion; and
a reinforcing portion that covers the reinforced portion to reinforce the upper member, wherein
the reinforcing portion is formed by melting thermoplastic resin powder adhered to the upper member, and hardening the melted thermoplastic resin powder to be firmly adhered to the upper member, and
the reinforced portion of the upper member that is reinforced by the reinforcing portion is smaller in thickness than a portion other than the reinforced portion in the upper member.

12. The shoe upper according to claim 10 or 11, wherein
the reinforcing portion is located in one of
a portion of the upper member that covers a toe of a foot,
a portion of the upper member that covers a side surface of a middle foot portion of the foot, and
a portion of the upper member that covers a heel of the foot.

13. A shoe comprising:
the shoe upper according to claim 11; and
a shoe sole provided below the shoe upper.

14. The method of manufacturing a shoe upper according to claim 2, wherein the adhering the thermoplastic resin powder to the upper member is performed by immersing the upper member in the thermoplastic resin powder in a convective state.

15. The method of manufacturing a shoe upper according to claim 14, wherein the pre-heating the upper member, the adhering the thermoplastic resin powder to the upper member, and the melting the thermoplastic resin powder adhered to the upper member are performed in a state where a last is inserted into the upper member.

16. The method of manufacturing a shoe upper according to claim 3, wherein the adhering the thermoplastic resin powder to the upper member is performed by immersing the upper member in the thermoplastic resin powder in a convective state.

17. The method of manufacturing a shoe upper according to claim 16, wherein the pre-heating the upper member, the adhering the thermoplastic resin powder to the upper member, and the melting the thermoplastic resin powder adhered to the upper member are performed in a state where a last is inserted into the upper member.

18. The method of manufacturing a shoe upper according to claim 4, wherein the pre-heating the upper member, the adhering the thermoplastic resin powder to the upper member, and the melting the thermoplastic resin powder adhered to the upper member are performed in a state where a last is inserted into the upper member.

19. The shoe upper according to claim 10, wherein
the reinforcing portion is located in one of
a portion of the upper member that covers a toe of a foot,
a portion of the upper member that covers a side surface of a middle foot portion of the foot, and
a portion of the upper member that covers a heel of the foot.

20. A shoe comprising:
the shoe upper according to claim 10; and
a shoe sole provided below the shoe upper.
